(19) United States
(12) Patent Application Publication
(10) Pub. No.: US 2026/0245786 A1
(43) Pub. Date: Aug. 20, 2026

(54) REACTOR AND METHOD FOR MANUFACTURING A REACTOR

(71) Applicant: Sumitomo Wiring Systems, Ltd., Yokkaichi-shi (JP)

(72) Inventors: Kai YOKOI, Yokkaichi-shi (JP); Masaya MURASHITA, Yokkaichi-shi (JP); Keiichiro YAMAMOTO, Yokkaichi-shi (JP); Takehiro KANO, Yokkaichi-shi (JP)

(73) Assignee: Sumitomo Wiring Systems, Ltd., Yokkaichi-shi (JP)

(21) Appl. No.: 19/541,046

(22) Filed: Feb. 16, 2026

(30) Foreign Application Priority Data
Feb. 18, 2025 (JP) 2025-024206

(51) Int. Cl. H01F 27/28

(52) U.S. Cl. CPC H01F 27/2823

(57) ABSTRACT

A reactor includes a coil, a core having a middle core portion disposed to penetrate through the inside of the coil, two side core portions arranged side by side outside of the coil and on the sides of the middle core portion, and two end core portions arranged to connect an end portion of the middle core portion to end portions of the two side core portions, and an insulating resin portion covering the coil and the core. The reactor is arranged on a heat dissipation member. The insulating resin portion has a first end portion covering portion and a second end portion covering portion that are arranged between the coil and the end core portions when the coil and the core are attached. The first end portion covering portion has a heat dissipation plate portion disposed between the lower surface of the middle core portion and the coil.

### CROSS-REFERENCE TO RELATED APPLICATIONS

This application claims priority of Japanese Patent Application No. JP2025-024206 filed on February 18, 2025, the content of which is incorporated herein.

### TECHNICAL FIELD

The present disclosure relates to a reactor and a method for manufacturing a reactor.

### BACKGROUND

Conventionally, there is a reactor that includes a coil, a core, and an insulating resin portion (e.g., see JP 2022-45166A). The core has a middle core portion, two side core portions, and two end core portions. The middle core portion is disposed so as to penetrate through the inside of the coil. The two side core portions extend parallel to the middle core portion outside the coil and are arranged side by side on the sides of the middle core portion. The two end core portions are arranged so as to connect an end portion of the middle core portion to end portions of the two side core portions. The insulating resin portion covers at least part of the coil and the core.

JP 2022-45166A is an example of related art.

### SUMMARY

Incidentally, the reactor described above can have improved heat dissipation properties due to, for example, being disposed on a heat dissipation member such that the exposed lower surface of the coil comes into contact with the heat dissipation member. However, if the insulating resin portion is a molded resin portion that is simply molded onto the assembly of the coil and core, there is a risk that molten resin that will become the molded resin portion will not enter the narrow space between the lower surface of the middle core portion and the coil. Thus, there is a risk of a gap being formed between the lower surface of the middle core portion and the coil. This poses a problem in that the heat from the middle core portion is not easily transferred to the coil and consequently to the heat dissipation member.

An object of the present disclosure is to provide a reactor capable of improving heat dissipation properties and a method for manufacturing the reactor.

A reactor according to the present disclosure is a reactor to be disposed on a heat dissipation member, including: a coil; a core having a middle core portion disposed so as to penetrate through the inside of the coil, two side core portions that extend parallel to the middle core portion outside of the coil and are arranged side by side on sides of the middle core portion, and two end core portions arranged so as to connect an end portion of the middle core portion to end portions of the two side core portions; and an insulating resin portion covering at least part of the coil and the core, in which the insulating resin portion has two end portion covering portions that can be arranged to cover both ends of the coil when the core is not attached and are arranged between the coil and the end core portion when the coil and the core are attached, and at least one of the two end portion covering portions has a heat dissipation plate portion disposed between a lower surface of the middle core portion and the coil.

According to the reactor and the method for manufacturing the reactor of the present disclosure, heat dissipation properties can be improved.

### BRIEF DESCRIPTION OF THE DRAWINGS

FIG. 1 is a perspective view of a reactor according to an embodiment;

FIG. 2 is a perspective view of part of the reactor according to the embodiment;

FIG. 3 is a plan view of the reactor according to the embodiment;

FIG. 4 is an exploded perspective view of part of the reactor according to the embodiment;

FIG. 5 is an exploded perspective view of part of the reactor according to the embodiment;

FIG. 6 is a plan view of part of the reactor according to the embodiment;

FIG. 7 is a plan view of an integrally molded member according to the embodiment;

FIG. 8 is a side view of an integrally molded member according to the embodiment;

FIG. 9 is a perspective view of an integrally molded member according to the embodiment;

FIG. 10 is a schematic exploded perspective view of an integrally molded member according to the embodiment;

FIG. 11 is a cross-sectional view taken along line 11-11 in FIG. 3;

FIG. 12 is a cross-sectional view taken along line 12-12 in FIG. 3;

FIG. 13 is a perspective view of a second end portion covering portion according to the embodiment;

FIG. 14 is an enlarged perspective view of part of the reactor according to the embodiment;

FIG. 15 is an enlarged perspective view of part of the reactor according to the embodiment;

FIG. 16 is an enlarged side view of part of the reactor according to the embodiment; and

FIG. 17 is a cross-sectional view taken along line 17-17 in FIG. 16.

### DETAILED DESCRIPTION OF PREFERRED EMBODIMENTS

First, embodiments of the present disclosure will be listed and described.

[1] A reactor according to the present disclosure is a reactor to be disposed on a heat dissipation member, including: a coil; a core having a middle core portion disposed so as to penetrate through the inside of the coil, two side core portions that extend parallel to the middle core portion outside of the coil and are arranged side by side on sides of the middle core portion, and two end core portions arranged so as to connect an end portion of the middle core portion to end portions of the two side core portions; and an insulating resin portion covering at least part of the coil and the core, in which the insulating resin portion has two end portion covering portions that can be arranged to cover both ends of the coil when the core is not attached and are arranged between the coil and the end core portion when the coil and the core are attached, and at least one of the two end portion covering portions has a heat dissipation plate portion disposed between a lower surface of the middle core portion and the coil.

According to this configuration, the insulating resin portion has the two end portion covering portions that can be arranged to cover both ends of the coil when the core is not attached and are arranged between the coil and the end core portions, and therefore the intervals between the coil and the end core portions are maintained. Also, at least one of the two end portion covering portions has the heat dissipation plate portion disposed between the lower surface of the middle core portion and the coil, and therefore heat from the middle core portion can be favorably transferred to the heat dissipation member through the heat dissipation plate portion and the coil. That is, if the space between the lower surface of the middle core portion and the coil is set narrow, there is a risk that even if an attempt is made to pour in the molten resin that will become the insulating resin portion when the coil and core are attached, the molten resin will not enter the space and a gap will form. In contrast, the end portion covering portions, which can be arranged to cover both ends of the coil when the core is not attached, have the heat dissipation plate portion disposed between the lower surface of the middle core portion and the coil, thereby preventing a gap from forming between the lower surface of the middle core portion and the coil. Thus, the heat from the middle core portion can be favorably transferred to the heat dissipation member through the heat dissipation plate portion and the coil.

[2] In [1] above the end portion covering portions may have side plate portions that stand upright from both sides of the heat dissipation plate portion and are arranged between side surfaces of the middle core portion and the coil.

According to this configuration, the end portion covering portion has the side plate portions that stand upright from both sides of the heat dissipation plate portion and are arranged between the side surfaces of the middle core portion and the coil. For this reason, heat from the middle core portion can be favorably transferred to the heat dissipation member through the side plate portions, the heat dissipation plate portion, and the coil. That is, if the space between the side surfaces of the middle core portion and the coil is set narrow, there is a risk that even if an attempt is made to pour in molten resin that will become the insulating resin portion when the coil and core are attached, the molten resin will not enter the space and a gap will form. In contrast, the end portion covering portion, which can be disposed to cover both ends of the coil when the core is not attached, has side plate portions that are arranged between the side surfaces of the middle core portion and the coil, thereby preventing gaps from forming between the side surfaces of the middle core portion and the coil. Thus, the heat from the middle core portion can be favorably transferred to the heat dissipation member through the side plate portions, the heat dissipation plate portion, and the coil.

[3] In [2] above, the side plate portions may have inclined portions whose height from the heat dissipation plate portion decreases toward a leading end in a direction of insertion into the coil.

According to this configuration, the side plate portions have the inclined portions whose height from the heat dissipation plate portion decreases toward the leading end in the direction of insertion into the coil. For this reason, the ease of attachment when attaching the end portion covering portion to the coil is improved.

[4] In any one of [1] to [3] above, the two end portion covering portions may be constituted by a first end portion covering portion and a second end portion covering portion, and the first end portion covering portion may have the heat dissipation plate portion and two arm portions that extend to be connected to the second end portion covering portion and are capable of supporting the coil from below.

According to this configuration, the two end portion covering portions are constituted by the first end portion covering portion and the second end portion covering portion, and the first end portion covering portion has the heat dissipation plate portion and two arm portions that extend to be connected to the second end portion covering portion and can support the coil from below. For this reason, the second end portion covering portion is a small component. That is, the heat dissipation plate portion and the two arm portions, which would increase the size of the component, are integrated into the first end portion covering portion, and therefore the second end portion covering portion can be a small component. Thus, for example, compared to a configuration in which the first end portion covering portion has the heat dissipation plate portion and the second end portion covering portion has the two arm portions, the mold for molding the second end portion covering portion can be made smaller.

[5] In any one of [1] to [4] above the insulating resin portion may have the two end portion covering portions as primary molded portions, and a molded resin portion serving as a secondary molded portion that covers at least part of the coil and the core.

According to this configuration, the insulating resin portion has the two end portion covering portions as primary molded portions and the molded resin portion serving as a secondary molded portion that covers at least part of the coil and the core. For this reason, the coil and the core are further protected.

[6] A method for manufacturing a reactor of the present disclosure is a method for manufacturing a reactor to be disposed on a heat dissipation member, the reactor including: a coil; a core having a middle core portion disposed so as to penetrate through the inside of the coil, two side core portions that extend parallel to the middle core portion outside of the coil and are arranged side by side on sides of the middle core portion, and two end core portions arranged so as to connect an end portion of the middle core portion to end portions of the two side core portions; and an insulating resin portion covering at least part of the coil and the core, the method including: a primary molding step of molding two end portion covering portions that constitute at least part of the insulating resin portion, can be arranged to cover both ends of the coil when the core is not attached, and are arranged between the coil and the end core portion when the coil and the core are attached, in which in the primary molding step, a heat dissipation plate portion disposed between a lower surface of the middle core portion and the coil is molded in at least one of the two end portion covering portions.

According to this method, through the primary molding step, the two end portion covering portions are molded that constitute at least part of the insulating resin portion, can be arranged to cover both ends of the coil when the core is not attached, and are arranged between the coil and the end core portions. Thus, the intervals between the coil and the end core portions are maintained. Also, the heat dissipation plate portion that is disposed between the lower surface of the middle core portion and the coil is molded on at least one of the two end portion covering portions. For this reason, heat from the middle core portion can be favorably transferred to the heat dissipation member through the heat dissipation plate portion and the coil. That is, if the space between the lower surface of the middle core portion and the coil is set narrow, there is a risk that even if an attempt is made to pour in the molten resin that will become the insulating resin portion when the coil and core are attached, the molten resin will not enter the space and a gap will form. In contrast, the end portion covering portion, which can be disposed to cover both ends of the coil when the core is not attached, has a heat dissipation plate portion disposed between the lower surface of the middle core portion and the coil, thereby preventing a gap from forming between the lower surface of the middle core portion and the coil. Thus, the heat from the middle core portion can be favorably transferred to the heat dissipation member through the heat dissipation plate portion and the coil.

Specific examples of the reactor of the present disclosure will be described below with reference to the drawings. In each drawing, for convenience of description, portions of the configuration may be exaggerated or simplified. For example, in each drawing, some chamfered shapes may be omitted. In addition, the dimensional proportions of each portion may differ between drawings.

The term “cylindrical” as used in the description of this specification does not only refer to a cylindrical member having a continuous peripheral wall formed around the entire circumference in the circumferential direction, but also includes a cylindrical member formed by combining a plurality of components. “Cylindrical” outer peripheral shapes include, but are not limited to, circles, ellipses, and polygons with sharp or rounded corners. The term “cylindrical” refers to a shape having a through hole in a plan view, and includes shapes in which the outer peripheral shape and the inner peripheral shape of the through hole are the same, and shapes in which the outer peripheral shape and the inner peripheral shape of the through hole are different. The term “cylindrical” includes shapes having a predetermined length extending along an axial direction of a central axis passing through the center of a through hole, and the length may be set as appropriate.

Terms such as “first”, “second”, and “third” are used herein merely to distinguish between objects and do not rank the objects.

Note that the present disclosure is not limited to these examples, but is defined by the scope of the claims, and all modifications within the meaning and scope equivalent to the claims are intended to be encompassed therein.

In each drawing, a first axis X, a second axis Y perpendicular to the first axis X, and a third axis Z perpendicular to the first axis X and the second axis Y are shown. Also, in the drawings, a first direction X1, which is one direction along the first axis X, and a first opposite direction X2, which is the opposite direction to the first direction X1, are shown. Also, in the drawings, an upward direction Z1, which is one direction along the third axis Z, and a downward direction Z2, which is the opposite direction to the upward direction Z1, are shown. The upward direction Z1 and the downward direction Z2 are directions in a state in which, for example, the reactor 20 is fixed to a fixed object (not shown).

### Configuration of Reactor 20

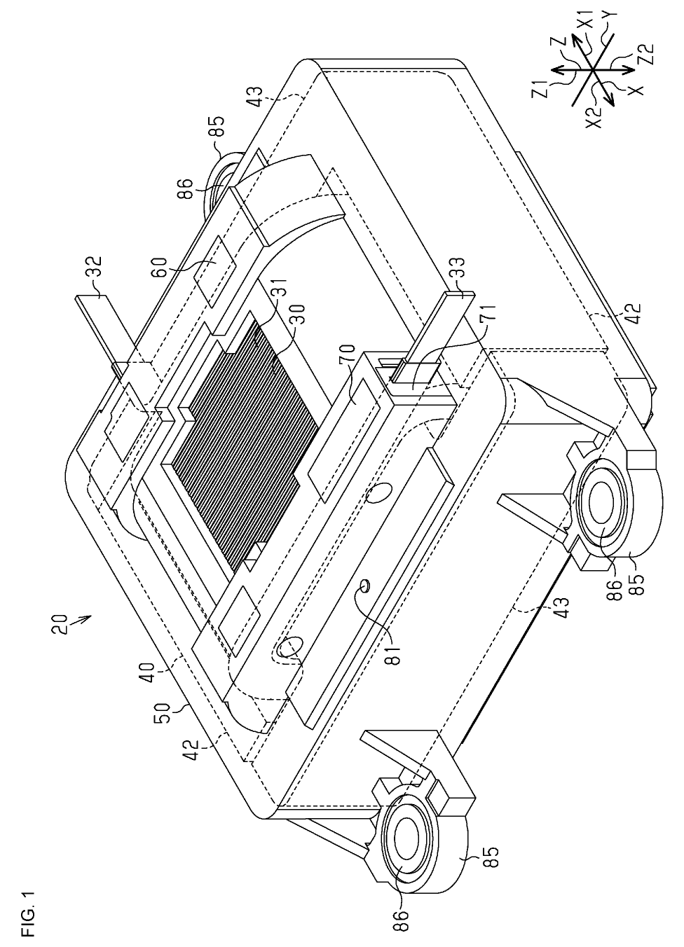

As shown in FIGS. 1 to 3, the reactor 20 includes a coil 30, a core 40, and an insulating resin portion 50. The reactor 20 is used, for example, as a constituent component of a converter mounted in a vehicle such as an electric vehicle or a hybrid vehicle, or as a constituent component of a power conversion device including the converter. Examples of the converter include a DC-DC converter and an AC-DC converter.

### Configuration of Coil 30

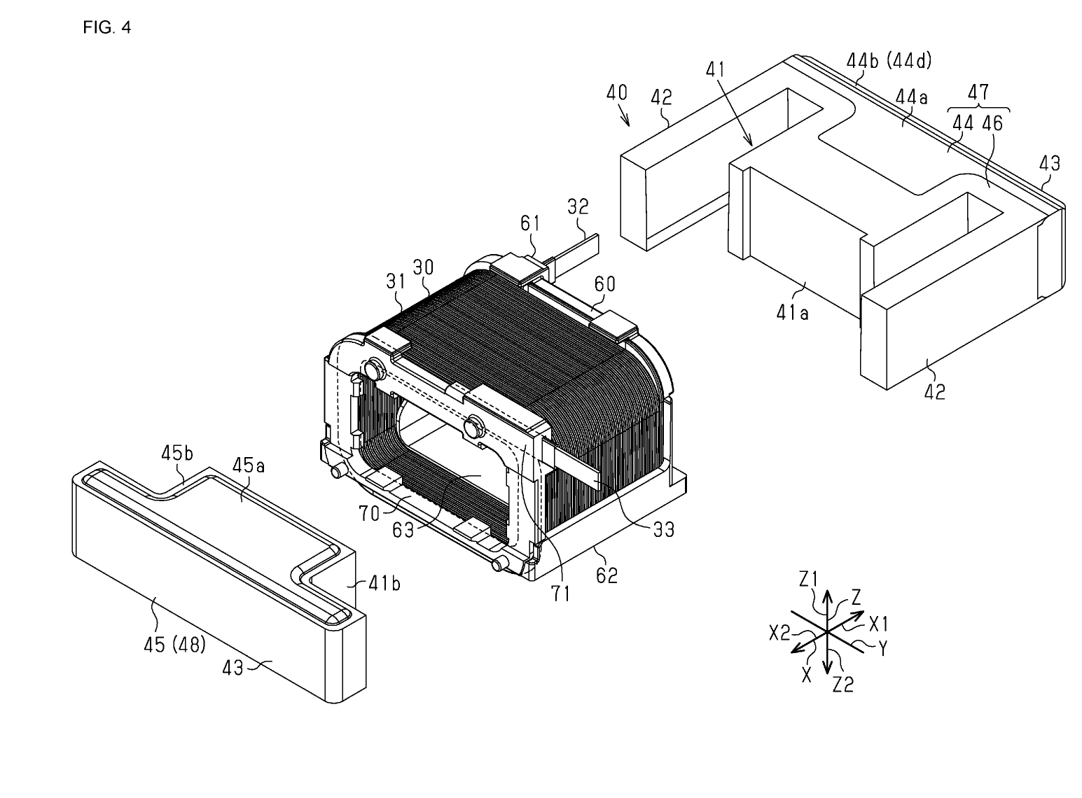

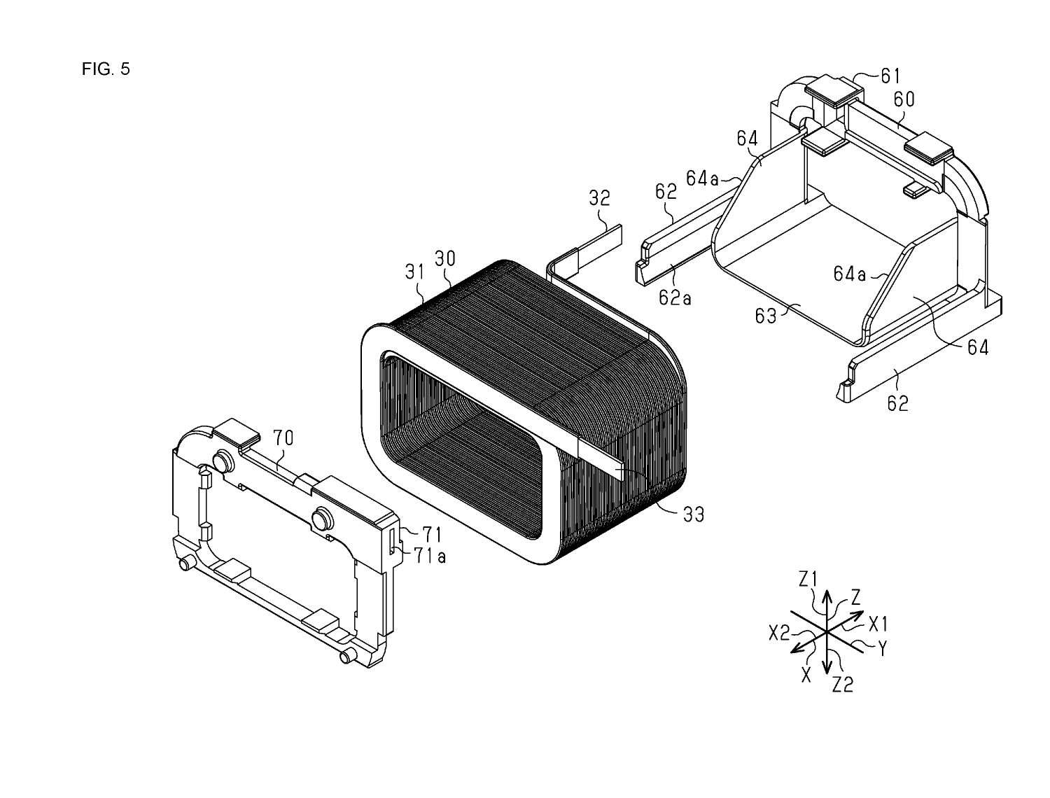

As shown in FIGS. 4 and 5, the coil 30 has a winding portion 31 formed by winding a winding wire in a spiral shape. A known winding wire can be used as the winding wire. The winding wire of this embodiment is a coated rectangular wire having a conductor wire and an insulating coating. The conductor wire is made of, for example, a rectangular wire made of copper or a copper alloy. The insulating coating is made of, for example, enamel. The winding portion 31 is formed by, for example, performing edgewise-winding of a coated rectangular wire. The winding portion 31 is formed in a cylindrical shape. The winding portion 31 of this embodiment is formed in a rectangular cylindrical shape.

The coil 30 has terminal portions 32 and 33. The terminal portions 32 and 33 and the winding portion 31 are formed continuously and integrally. That is, the terminal portions 32 and 33 are formed by both end portions of the winding portion 31. The insulating coating is stripped off from the leading end of each of the terminal portions 32 and 33 to expose the conductor wire. Each of the terminal portions 32 and 33 is formed so as to be drawn out from the winding portion 31 to the outside. One terminal portion 32 is drawn out along the first axis X, that is, along the central axis of the winding portion 31. The other terminal portion 33 is drawn out along the second axis Y and is drawn out to the outer peripheral side of the winding portion 31. Each of the terminal portions 32 and 33 is to be connected, for example, by welding or the like to a connection terminal (not shown) of a device in which the reactor 20 is mounted.

### Configuration of Core 40

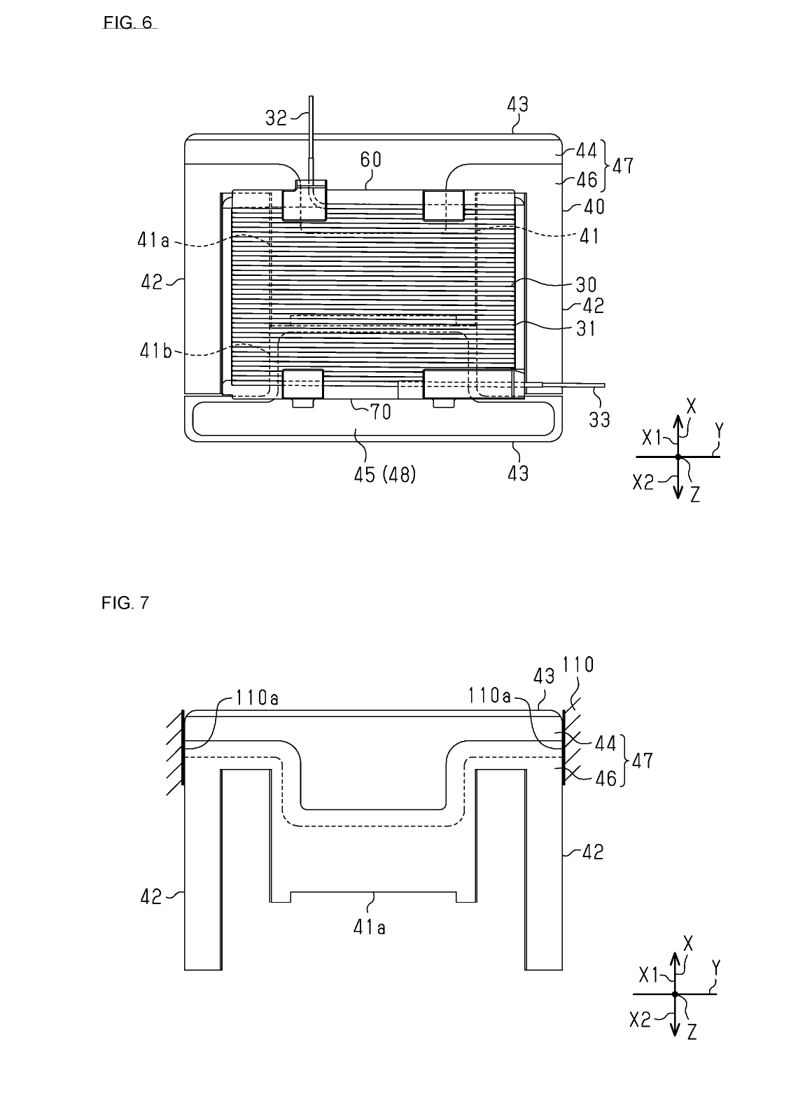

As shown in FIG. 6, the core 40 has a middle core portion 41, two side core portions 42, and two end core portions 43. The middle core portion 41 is disposed so as to penetrate through the inside of the coil 30, and more specifically, the inside of the winding portion 31. The two side core portions 42 extend parallel to the middle core portion 41 outside the coil 30 and are arranged side by side on the sides of the middle core portion 41 at positions between which the middle core portion 41 is interposed. The two end core portions 43 are arranged so as to connect an end portion of the middle core portion 41 and end portions of the two side core portions 42.

As shown in FIGS. 4 and 6, the core 40 is classified according to the manufacturing method and the like, and includes an integrally molded member 47 that includes powder-compacted core portions 44 and 45 and a resin core portion 46, and in which the resin core portion 46 is molded using the powder-compacted core portion 44 as an insert. The powder-compacted core portions 44 and 45 are constituted by powder-compacted bodies of soft magnetic powder. The resin core portion 46 is constituted by a molded body of a composite material formed by dispersing soft magnetic powder in resin.

Examples of materials for the soft magnetic powder include pure iron, iron alloys, and non-metals such as ferrite. Examples of iron alloys include Fe-Si alloys and Fe-Ni alloys.

Examples of resins in composite materials include thermosetting resins and thermoplastic resins. Examples of thermosetting resins include epoxy resin, phenol resin, silicone resin, and urethane resin. Examples of thermoplastic resins include polyphenylene sulfide (PPS) resin, polyamide (PA) resin (e.g., nylon 6, nylon 66, nylon 9T, etc.), liquid crystal polymer (LCP), polyimide (PI) resin, and fluororesin. The composite material may contain a filler in addition to the resin.

The core 40 of this embodiment is constituted by the integrally molded member 47 and a powder-compacted core member 48. The integrally molded member 47 has a first middle core constituent portion 41a that is part of the middle core portion 41, the two side core portions 42, and one of the two end core portions 43. The powder-compacted core member 48 is made of the powder-compacted core portion 45 and has a second middle core constituent portion 41b that is part of the middle core portion 41, and one of the two end core portions 43.

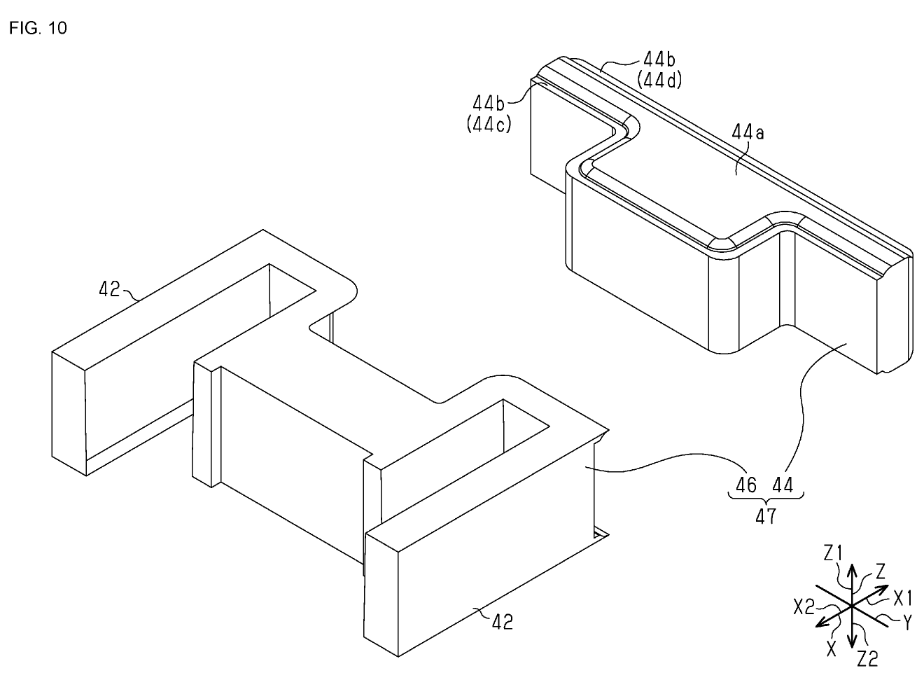

As shown in FIG. 10, in the integrally molded member 47, the powder-compacted core portion 44 is formed in a T shape so as to constitute part of the end core portion 43 (see FIG. 4) and constitute part of the first middle core constituent portion 41a (see FIG. 4). In addition, in the integrally molded member 47, the powder-compacted core portion 44 has a low portion 44b on the outer peripheral edge as viewed in a compression direction during molding, the height of the low portion 44b along the compression direction being lower than a flat portion 44a of another part of the powder-compacted core portion. Note that the low portion 44b is, for example, a level difference designed to increase the durability of a mold when molding the powder-compacted core portion 44. In this embodiment, the flat portion 44a and the low portion 44b are connected by a curved surface whose height changes smoothly. In addition, in FIG. 10, the resin core portion 46, which is integrally molded with the powder-compacted core portion 44 and is not molded independently, is shown in a state of being separated from the powder-compacted core portion 44 in a schematic manner. The compression direction is a direction along the third axis Z in the drawing. In this embodiment, the surface in the upward direction Z1 of the integrally molded member 47, that is, the upper surface, will be described, but the surface in the downward direction Z2 of the integrally molded member 47, that is, the lower surface, also has a similar shape.

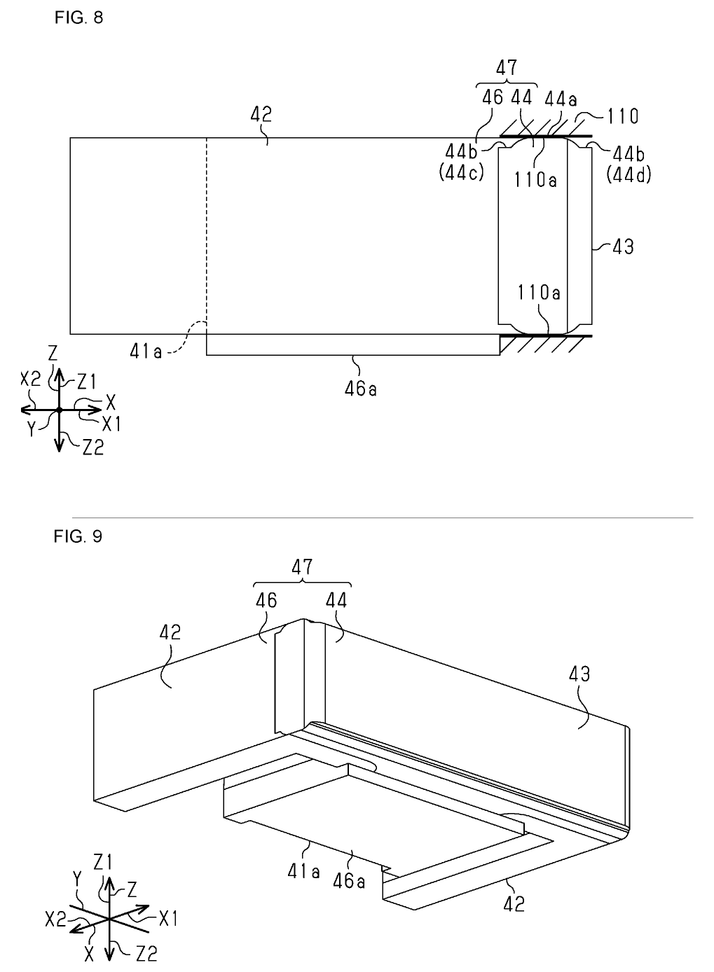

As shown in FIGS. 4 and 8, in the integrally molded member 47, the resin core portion 46 is connected to part of the powder-compacted core portion 44 in a view in the compression direction, and is formed flush with the flat portion 44a. In the integrally molded member 47, the resin core portion 46 is formed flush with the side surfaces of the powder-compacted core portion 44 as well.

As shown in FIGS. 8 and 10, the low portion 44b has a connected low portion 44c that is connected to the resin core portion 46 and a non-connected low portion 44d that is not connected to the resin core portion 46 at the outer peripheral edge of the powder-compacted core portion 44 in a view in the compression direction. The connected low portion 44c and the non-connected low portion 44d are provided separately from each other. In other words, the connected low portion 44c and the non-connected low portion 44d are not connected to each other due to the flat portion 44a being provided therebetween.

As shown in FIG. 6, in this embodiment, in the integrally molded member 47, the powder-compacted core portion 44 constitutes part of the end core portion 43 and is formed up to both ends of the end core portion 43 along the direction in which the middle core portion 41 and the two side core portions 42 are connected. The flat portion 44a separating the connected low portion 44c (see FIG. 10) and the non-connected low portion 44d is formed up to both ends of the powder-compacted core portion 44 along the direction in which the middle core portion 41 (more specifically, the first middle core constituent portion 41a) and the two side core portions 42 are connected. In other words, in the integrally molded member 47, the powder-compacted core portion 44 is formed up to both ends of the end core portion 43 along the second axis Y, and the flat portion 44a is also formed up to both ends of the end core portion 43 along the second axis Y.

As shown in FIG. 4, in the integrally molded member 47 of this embodiment, the resin core portion 46 is formed in a shape that constitutes the two side core portions 42, constitutes part of the end core portion 43, and constitutes part of the first middle core constituent portion 41a. The resin core portion 46 and the powder-compacted core portion 44 are formed in an E shape. As shown in FIGS. 8 and 9, the resin core portion 46 of this embodiment has a downward bulging portion 46a that bulges in the downward direction Z2 from a portion corresponding to the first middle core constituent portion 41a.

As shown in FIG. 4, the powder-compacted core portion 45 constituting the powder-compacted core member 48 is formed in a T shape so as to constitute the end core portion 43 and the second middle core constituent portion 41b. The powder-compacted core portion 45 constituting the powder-compacted core member 48 has a low portion 45b on the outer peripheral edge as viewed in the compression direction when molded, the height of the low portion 45b along the compression direction being lower than a flat portion 45a of another portion of the powder-compacted core portion. Note that the low portion 45b is a level difference designed to increase the durability of a mold when molding the powder-compacted core portion 45, for example. In this embodiment, the flat portion 45a and the low portion 45b are connected by a curved surface whose height changes smoothly. The compression direction is a direction along the third axis Z in the drawing. In this embodiment, the surface in the upward direction Z1 of the powder-compacted core member 48, that is, the upper surface, will be described, but the surface in the downward direction Z2 of the powder-compacted core member 48, that is, the lower surface, also has a similar shape. The low portion 45b of the powder-compacted core portion 45 constituting the powder-compacted core member 48 is formed around the entire outer peripheral edge of the powder-compacted core portion 45 as viewed in the compression direction.

### Configuration of Insulating Resin Portion 50

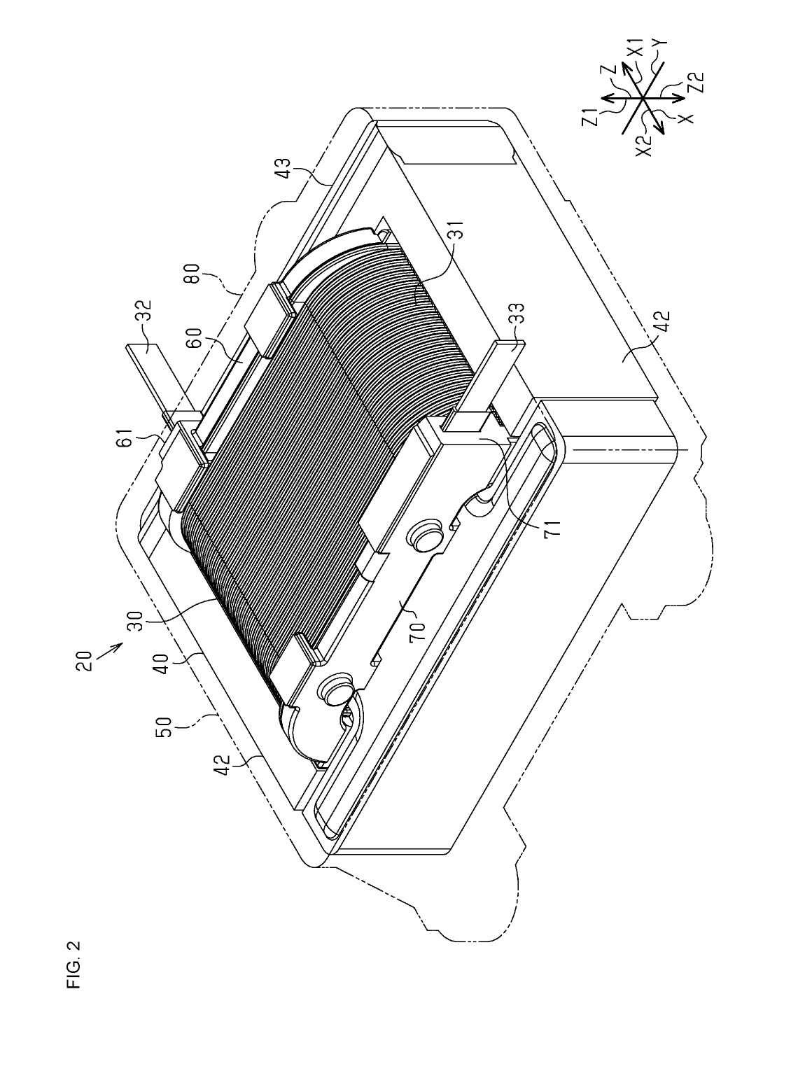

As shown in FIGS. 1 to 3, the insulating resin portion 50 covers at least part of the coil 30 and the core 40. As shown in FIG. 2, the insulating resin portion 50 has a first end portion covering portion 60 and a second end portion covering portion 70 that are primary molded portions and constitute two end portion covering portions, and a molded resin portion 80 that is a secondary molded portion.

The first end portion covering portion 60, the second end portion covering portion 70, and the molded resin portion 80 can be made of a thermoplastic resin, for example. Examples of the thermoplastic resin include polyphenylene sulfide (PPS) resin, polytetrafluoroethylene (PTFE) resin, liquid crystal polymer (LCP), and polyamide (PA) resin. Examples of the thermoplastic resin include polybutylene terephthalate (PBT) resin and acrylonitrile butadiene styrene (ABS) resin. The materials of the first end portion covering portion 60, the second end portion covering portion 70, and the molded resin portion 80 may be the same as or different from each other.

### Configuration of First End Portion Covering Portion 60 and Second End Portion Covering Portion 70

As shown in FIGS. 4 and 5, the first end portion covering portion 60 and the second end portion covering portion 70 can be arranged to cover both ends of the coil 30 when the core 40 (see FIG. 4) is not attached. In addition, the first end portion covering portion 60 and the second end portion covering portion 70 are disposed between the coil 30 and the end core portions 43 when the coil 30 and the core 40 are attached (see FIGS. 2 and 6). More specifically, the first end portion covering portion 60 is formed so as to be attachable to the end portion in the first direction X1 of the winding portion 31 while covering the end portion. The second end portion covering portion 70 is formed so as to be attachable to the end portion in the first opposite direction X2 of the winding portion 31 while covering the end portion.

The first end portion covering portion 60 also has a terminal support portion 61 that supports the terminal portion 32 drawn out along the first axis X. The terminal support portion 61 supports a base portion of the terminal portion 32 from which the insulating coating has not been stripped. The second end portion covering portion 70 also has a terminal support portion 71 that supports the terminal portion 33 drawn out along the second axis Y. The terminal support portion 71 supports a base portion of the terminal portion 33 from which the insulating coating has not been stripped.

As shown in FIG. 5, the first end portion covering portion 60 has two arm portions 62 that extend so as to be connected to the second end portion covering portion 70 and that can support the coil 30 from below. The two arm portions 62 extend along the first axis X from both end portions along the second axis Y at the end portion in the downward direction Z2 of the first end portion covering portion 60.

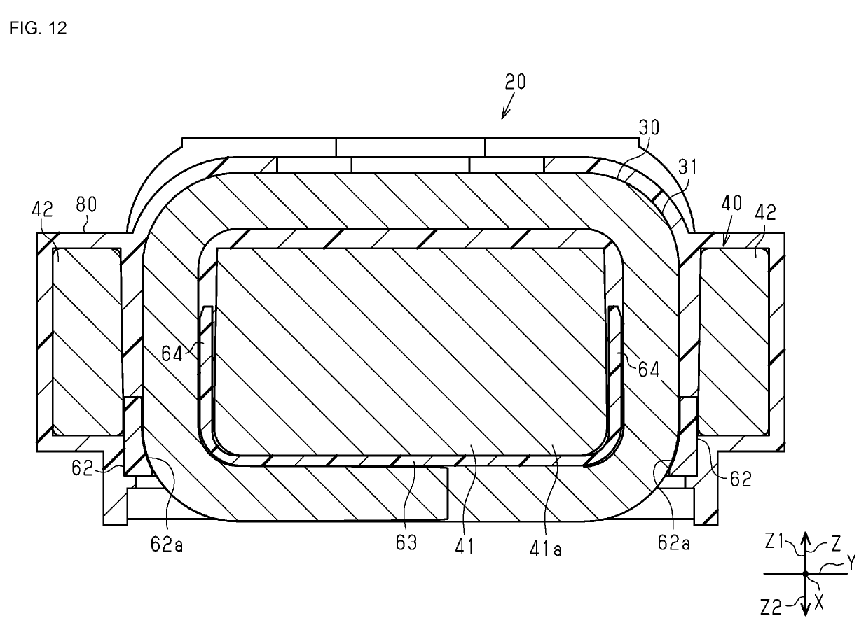

As shown in FIG. 12, the two arm portions 62 have curved support surfaces 62a that can, in the upward direction Z1 from the downward direction Z2, support the curved surfaces of both end portions along the second axis Y in the winding portion 31 of the coil 30.

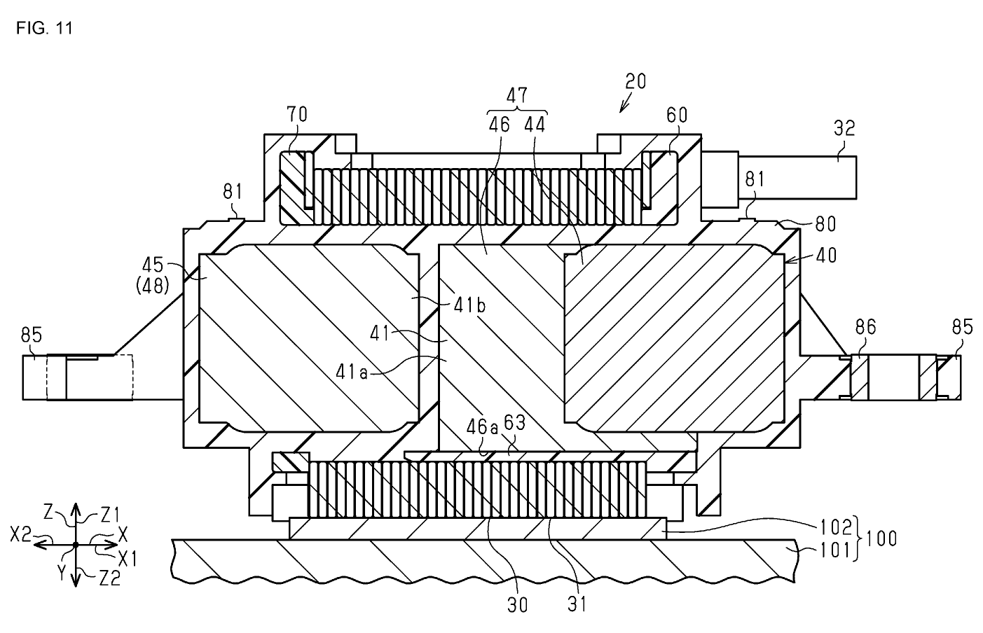

As shown in FIG. 5, the first end portion covering portion 60 has a heat dissipation plate portion 63. As shown in FIGS. 11 and 12, the heat dissipation plate portion 63 is disposed between the lower surface of the middle core portion 41 and the coil 30. As shown in FIG. 11, the heat dissipation plate portion 63 of this embodiment is formed in a shape that can cover the entire lower surface of the first middle core constituent portion 41a in the middle core portion 41, and more specifically, is formed in a shape that can cover the entire downward bulging portion 46a. That is, the heat dissipation plate portion 63 in this embodiment is disposed between the lower surface of the first middle core constituent portion 41a, which has a narrow gap due to including the downward bulging portion 46a, and the coil 30, in the space between the lower surface of the middle core portion 41 and the coil 30.

As shown in FIG. 5, the first end portion covering portion 60 has side plate portions 64. As shown in FIG. 12, the side plate portions 64 are provided standing upright from both sides of the heat dissipation plate portion 63 and are arranged between the side surfaces of the middle core portion 41 and the coil 30. As shown in FIG. 5, the side plate portions 64 have inclined portions 64a whose height from the heat dissipation plate portion 63 decreases toward the leading end in the direction of insertion into the coil 30.

### Configuration of Molded Resin Portion 80

As shown in FIGS. 2 and 11, the molded resin portion 80 is formed such that the coil 30, the core 40, the first end portion covering portion 60, and the second end portion covering portion 70 are at least partially covered when they are attached. The molded resin portion 80 of this embodiment is molded to cover the coil 30, the core 40, the first end portion covering portion 60, and the second end portion covering portion 70 such that the upper and lower surfaces and the terminal portions 32 and 33 of the winding portion 31 of the coil 30 are exposed, while most of the other portions are not exposed.

As shown in FIGS. 1, 3 and 11, the molded resin portion 80 has a gate mark 81. Note that the gate mark 81 is a mark that is created during injection molding to form the molded resin portion 80, and is a mark that is created due to the molten resin passing through a gate.

As shown in FIG. 11, the gate mark 81 is disposed at a position at which the path to the space between the upper surface of the middle core portion 41 and the coil 30 above the heat dissipation plate portion 63 is shorter than the path to the heat dissipation plate portion 63. In other words, the position of the gate mark 81 is set such that when the molded resin portion 80 is molded, the molten resin that will become the molded resin portion 80 reaches the space between the upper surface of the middle core portion 41 and the coil 30 above the heat dissipation plate portion 63 before reaching the heat dissipation plate portion 63.

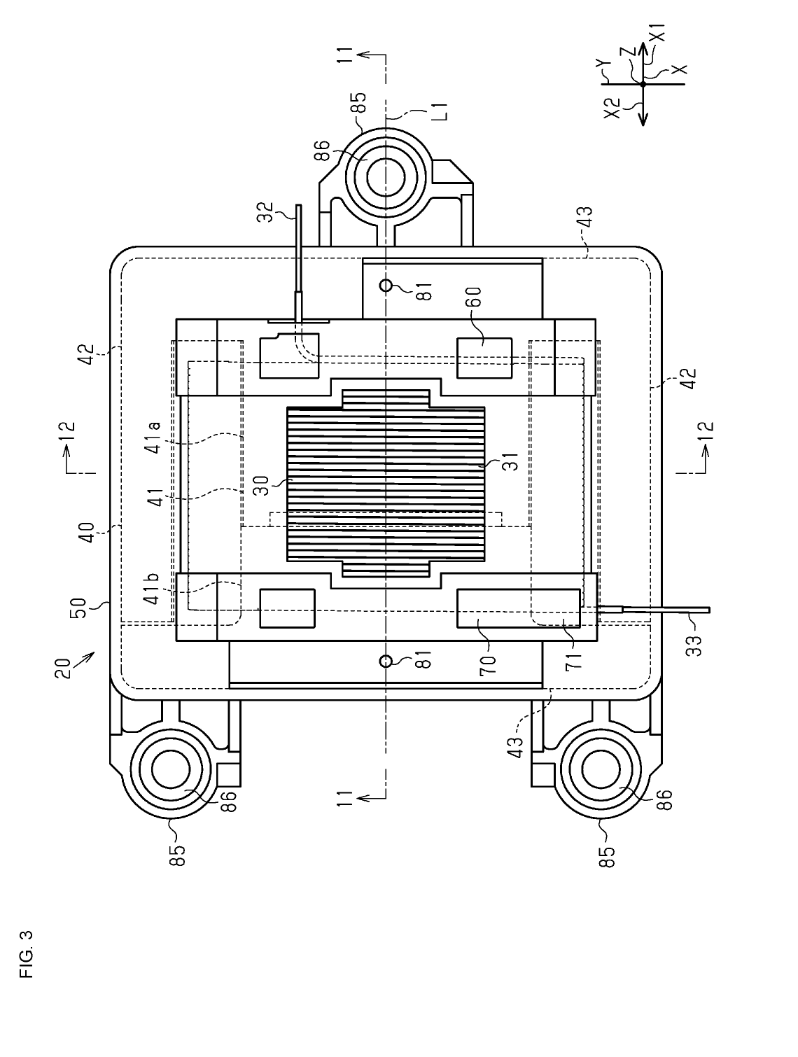

Specifically, as shown in FIG. 3, the gate mark 81 is disposed on the upper surface of the molded resin portion 80. The gate mark 81 is disposed on a central axis L1 of the middle core portion 41 as viewed from the upward direction Z1. Two gate marks 81 are disposed on the central axis L1 of the middle core portion 41 as viewed from the upward direction Z1, at positions between which the coil 30 is interposed, the positions being outside both ends of the coil 30. Note that the gate marks 81 of the molded resin portion 80 are not limited to the two gate marks 81 described above, and may be provided, for example, at positions farther away from the heat dissipation plate portion 63 than the gate marks 81 described above.

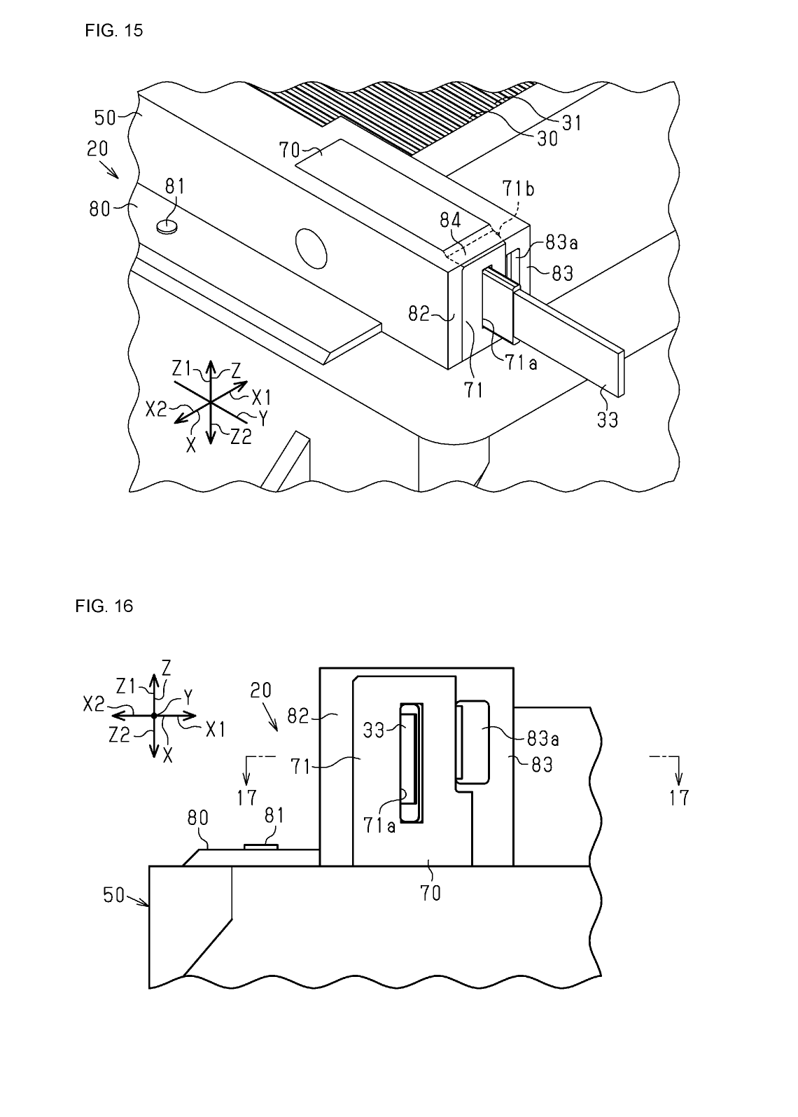

As shown in FIGS. 15 to 17, the molded resin portion 80 has a first wall 82 that covers a surface of the terminal support portion 71 of the second end portion covering portion 70 located closer to the gate mark 81, and a second wall 83 that covers a surface of the terminal support portion 71 on the side opposite to the gate mark 81. Note that the gate mark 81 referred to here is the gate mark 81 closest to the first wall 82 and the second wall 83.

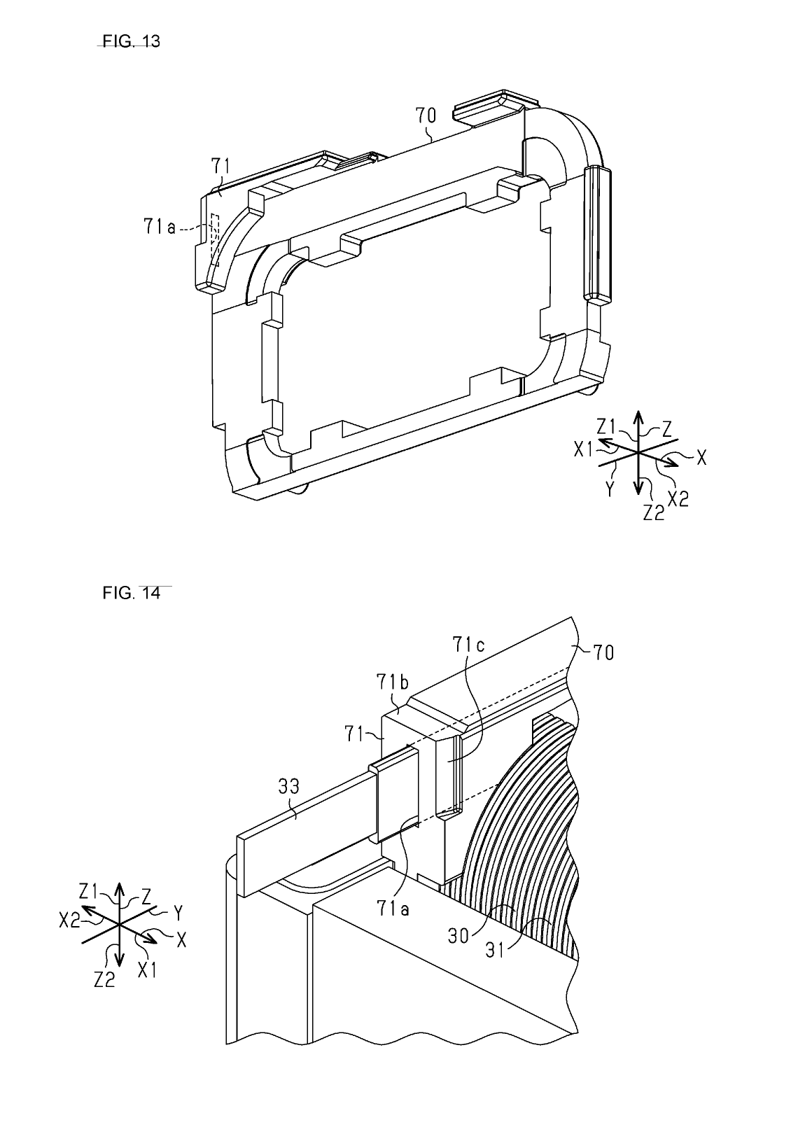

Specifically, as shown in FIGS. 5 and 14, the terminal support portion 71 of the second end portion covering portion 70 is provided at the end portion from which the terminal portion 33 is drawn out at the end portion in the upward direction Z1 of the second end portion covering portion 70. As shown in FIGS. 5, 13 and 14, the terminal support portion 71 has a terminal through hole 71a that penetrates along the second axis Y such that the terminal portion 33 drawn out along the second axis Y can pass through.

As shown in FIGS. 15 to 17, the first wall 82 is formed so as to cover the surface of the terminal support portion 71 located closer to the gate mark 81, which is the surface in the first opposite direction X2 of the terminal support portion 71. The second wall 83 is formed so as to cover the surface of the terminal support portion 71 on the side opposite to the gate mark 81, which is the surface in the first direction X1 of the terminal support portion 71.

In addition, the upper end surface of the terminal support portion 71, the upper end surface of the first wall 82, and the upper end surface of the second wall 83 are formed flush with each other. In addition, the end surface of the terminal support portion 71 in the direction in which the terminal portion 33 is led out, the end surface of the first wall 82 in the direction in which the terminal portion 33 is led out, and the end surface of the second wall 83 in the direction in which the terminal portion 33 is led out are formed flush with each other.

As shown in FIG. 15, the corner at the upper end of the terminal support portion 71 on the side from which the terminal portion 33 is led out has a flow path groove 71b that connects from the first wall 82 to the second wall 83. The molded resin portion 80 has a wall joining portion 84 that is disposed in the flow path groove 71b and connects the first wall 82 and the second wall 83.

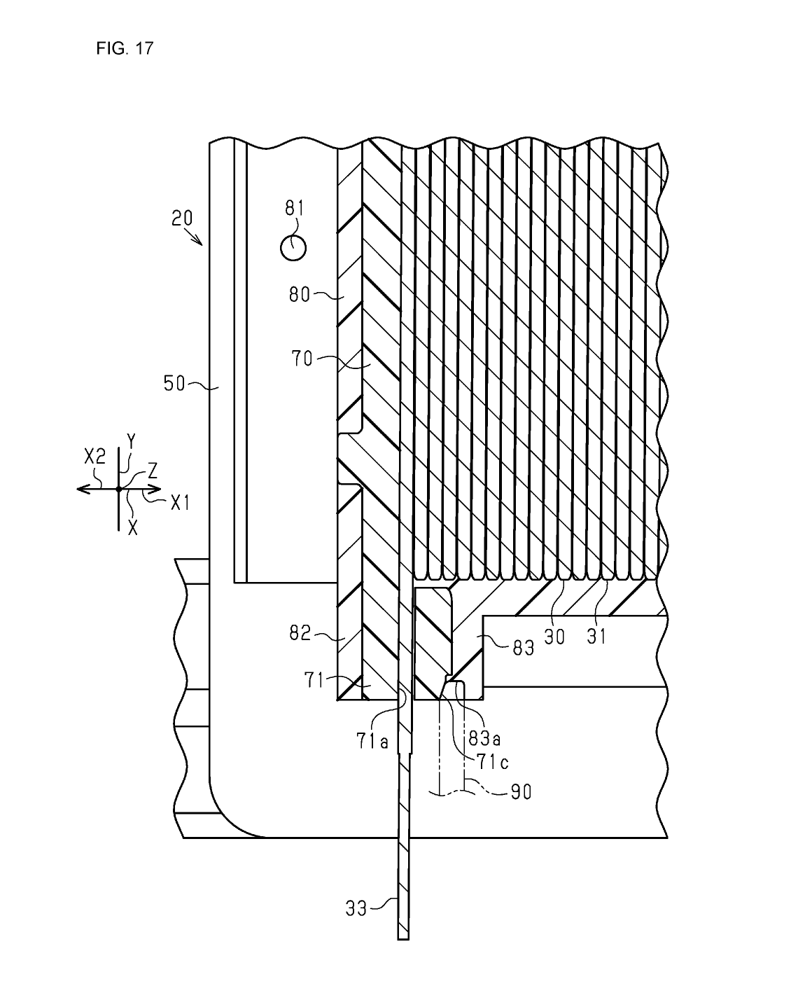

As shown in FIGS. 15 to 17, the second wall 83 has a recessed portion 83a including the surface of the terminal support portion 71 on the side opposite to the gate mark 81, which is the surface in the first direction X1 of the terminal support portion 71. As shown in FIG. 17, the recessed portion 83a is formed by disposing a slide core 90 separate from the upper and lower molds when molding the molded resin portion 80. As shown in FIGS. 14 and 17, the surface of the terminal support portion 71 on the side opposite to the gate mark 81, which is the surface in the first direction X1 of the terminal support portion 71, has an inclined surface 71c to facilitate the disposing of the slide core 90 (see FIG. 17).

As shown in FIG. 16, the recessed portion 83a is provided upward with respect to the terminal portion 33. In other words, the recessed portion 83a is provided at a position in the upward direction Z1 relative to the center of the terminal portion 33 along the third axis Z.

As shown in FIG. 3, the molded resin portion 80 has fixing portions 85. The molded resin portion 80 of this embodiment has three fixing portions 85. The three fixing portions 85 are provided so as to protrude in directions along the first axis X outward from the portions of the molded resin portion 80 that cover the end core portions 43.

More specifically, one of the three fixing portions 85 protrudes in the first direction X1 from the molded resin portion 80 on the central axis L1 of the middle core portion 41. In addition, two of the three fixing portions 85 protrude in the first opposite direction X2 from both ends of the molded resin portion 80 along the second axis Y. Metal collars 86 are fixed to the respective fixing portions 85. The fixing portions 85 are fixed to a fixing object by, for example, bolts that pass through the metal collars 86 and are screwed into the fixing object.

As shown in FIG. 11, the reactor 20 configured as described above is disposed on a heat dissipation member 100 such that, for example, the exposed lower surface of the coil 30, and more specifically, the lower surface of the winding portion 31, is in contact with the heat dissipation member 100. The heat dissipation member 100 is constituted by, for example, a heat dissipation base portion 101 through which cooling water (not shown) flows, and a heat dissipation sheet 102 that is disposed on the heat dissipation base portion 101 and is in contact with the lower surface of the coil 30.

### Method for Manufacturing Reactor 20

Next, a method for manufacturing the reactor 20 configured as described above and the operation thereof will be described.

The method for manufacturing the reactor 20 includes a core manufacturing step, a primary molding step, an attachment step, and a secondary molding step.

In the core manufacturing step, the integrally molded member 47 and the powder-compacted core member 48 that constitute the core 40 are molded. Here, the integrally molded member 47 is formed as a whole by first molding the powder-compacted core portion 44 and then molding the resin core portion 46 using the powder-compacted core portion 44 as an insert. Note that as shown in FIGS. 7 and 8, since the portion at which the resin core portion 46 is connected with the powder-compacted core portion 44 is flush with the powder-compacted core portion 44, in a mold 110 used in this case, the portion corresponding to the boundary between the powder-compacted core portion 44 and the resin core portion 46 is a simple flat surface 110a.

In the primary molding step, the first end portion covering portion 60 and the second end portion covering portion 70, which are primary molded portions that constitute part of the insulating resin portion 50 and that constitute two end portion covering portions, are molded. In the primary molding step of this embodiment, the heat dissipation plate portion 63 (see FIG. 5) that is to be disposed between the lower surface of the middle core portion 41 and the coil 30 is molded in the first end portion covering portion 60. In the primary molding step of this embodiment, the terminal support portions 61 and 71 that support the terminal portions 32 and 33 of the coil 30 are molded in the first end portion covering portion 60 and the second end portion covering portion 70.

After the core manufacturing step and the primary molding step, in the attachment step, the coil 30, the core 40, the first end portion covering portion 60, and the second end portion covering portion 70, which have been manufactured in advance, are attached to each other. At this time, first, as shown in FIG. 5 and then FIG. 4, the first end portion covering portion 60 and the second end portion covering portion 70 are attached to the coil 30, and then, as shown in FIG. 4 and then FIG. 6, the core 40 is attached.

Next, in the secondary molding step, the molded resin portion 80 serving as a secondary molded portion that constitutes part of the insulating resin portion 50 is molded. In the secondary molding step of this embodiment, the molded resin portion 80 is molded with the heat dissipation plate portion 63 disposed between the lower surface of the middle core portion 41 and the coil 30.

In the secondary molding step of this embodiment, the molten resin that will become the molded resin portion 80 is injected from the portion that will become the gate mark 81, such that it reaches the space between the upper surface of the middle core portion 41 and the coil 30 above the heat dissipation plate portion 63 before reaching the heat dissipation plate portion 63. In other words, in the secondary molding step of this embodiment, the molten resin that will become the molded resin portion 80 is injected from the portion that will become the gate mark 81 such that the molten resin that will become the molded resin portion 80 pushes the middle core portion 41 in the downward direction Z2.

In addition, in the secondary molding step of this embodiment, the gate mark 81, the first wall 82 covering the surface of the terminal support portion 71 located closer to the gate mark 81, and the second wall 83 covering the surface of the terminal support portion 71 on the side opposite to the gate mark 81 are molded in the molded resin portion 80. At this time, the recessed portion 83a is formed in the second wall 83 by bringing the slide core 90 into contact with the surface of the terminal support portion 71 on the side opposite to the gate mark 81 and injecting molten resin. In other words, in the secondary molding step, the second wall 83 having the recessed portion 83a is molded while positional misalignment of the terminal support portion 71 is prevented due to the slide core 90 supporting the surface of the terminal support portion 71 on the side opposite to the gate mark 81. In this way, the manufacture of the reactor 20 is completed.

### Effects of the Present Embodiment

Next, the effects of the above-described embodiment will be described below.

The insulating resin portion 50 has the first end portion covering portion 60 and the second end portion covering portion 70 serving as two end portion covering portions that can be arranged to cover both ends of the coil 30 when the core 40 is not attached, and are arranged between the coil 30 and the end core portions 43. Thus, the intervals between the coil 30 and the end core portions 43 are maintained. Also, since the first end portion covering portion 60 has the heat dissipation plate portion 63 disposed between the lower surface of the middle core portion 41 and the coil 30, heat from the middle core portion 41 can be favorably transferred to the heat dissipation member 100 through the heat dissipation plate portion 63 and the coil 30. That is, if the space between the lower surface of the middle core portion 41 and the coil 30 is set narrow, there is a risk that when the coil 30 and the core 40 are attached, the molten resin that will become the insulating resin portion 50 will not enter the space and a gap will form. In contrast, in this embodiment, the first end portion covering portion 60, which can be disposed to cover an end portion of the coil 30 when the core 40 is not attached, has the heat dissipation plate portion 63 disposed between the lower surface of the middle core portion 41 and the coil 30. Thus, a gap is prevented from forming between the lower surface of the middle core portion 41 and the coil 30. Thus, the heat from the middle core portion 41 can be favorably transferred to the heat dissipation member 100 through the heat dissipation plate portion 63 and the coil 30 . Thus, the reactor 20 has favorable heat dissipation properties.

The first end portion covering portion 60 has side plate portions 64 that stand upright from both sides of the heat dissipation plate portion 63 and are disposed between the side surfaces of the middle core portion 41 and the coil 30. Thus, the heat from the middle core portion 41 can be effectively transferred to the heat dissipation member 100 through the side plate portions 64, the heat dissipation plate portion 63, and the coil 30. That is, if the space between the side surface of the middle core portion 41 and the coil 30 is set narrow, there is a risk that when the coil 30 and the core 40 are attached, the molten resin that will become the insulating resin portion 50 will not enter the space and a gap will form. In contrast, in this embodiment, the first end portion covering portion 60, which can be disposed to cover an end portion of the coil 30 when the core 40 is not attached, has the side plate portions 64 that are arranged between the side surfaces of the middle core portion 41 and the coil 30. Thus, gaps are prevented from forming between the side surfaces of the middle core portion 41 and the coil 30. Thus, the heat from the middle core portion 41 can be favorably transferred to the heat dissipation member 100 through the side plate portions 64, the heat dissipation plate portion 63, and the coil 30. Thus, the reactor 20 has more favorable heat dissipation properties.

The side plate portions 64 have inclined portions 64a whose height from the heat dissipation plate portion 63 decreases toward the leading end in the direction of insertion into the coil 30. For this reason, the ease of attachment when attaching the first end portion covering portion 60 to the coil 30 is improved.

Since the first end portion covering portion 60 has the heat dissipation plate portion 63 and two arm portions 62 that extend to be connected to the second end portion covering portion 70 and can support the coil 30 from below, the second end portion covering portion 70 is a small component. That is, the heat dissipation plate portion 63 and the two arm portions 62, which would increase the size of the component, are integrated into the first end portion covering portion 60. For this reason, the second end portion covering portion 70 can be a small component. Thus, for example, compared to a configuration in which the first end portion covering portion 60 has the heat dissipation plate portion 63 and the second end portion covering portion 70 has the two arm portions 62, the mold for molding the second end portion covering portion 70 can be made smaller.

The insulating resin portion 50 has the first end portion covering portion 60 and the second end portion covering portion 70 as primary molded portions, and the molded resin portion 80 serving as a secondary molded portion that covers at least part of the coil 30 and the core 40. For this reason, the coil 30 and the core 40 are further protected.

Through the primary molding step, the first end portion covering portion 60 and the second end portion covering portion 70 serving as two end portion covering portions that can be arranged to cover both ends of the coil 30 when the core 40 is not attached and are arranged between the coil 30 and the end core portions 43, are molded. Thus, the intervals between the coil 30 and the end core portions 43 are maintained. Also, the heat dissipation plate portion 63 that is disposed between the lower surface of the middle core portion 41 and the coil 30 is molded in the first end portion covering portion 60, and therefore heat from the middle core portion 41 can be favorably transferred to the heat dissipation member 100 through the heat dissipation plate portion 63 and the coil 30. That is, if the space between the lower surface of the middle core portion 41 and the coil 30 is set narrow, there is a risk that when the coil 30 and the core 40 are attached, the molten resin that will become the insulating resin portion 50 will not enter the space and a gap will form. In contrast, in this embodiment, the first end portion covering portion 60, which can be disposed to cover an end portion of the coil 30 when the core 40 is not attached, has the heat dissipation plate portion 63 disposed between the lower surface of the middle core portion 41 and the coil 30. Thus, a gap is prevented from forming between the lower surface of the middle core portion 41 and the coil 30. Thus, the heat from the middle core portion 41 can be favorably transferred to the heat dissipation member 100 through the heat dissipation plate portion 63 and the coil 30 . Thus, the reactor 20 has favorable heat dissipation properties.

### Modified Examples

The above-described embodiment can be modified as follows. The above-described embodiment and the following modified examples can be implemented in combination with each other as long as no technical contradiction occurs.

In the above-described embodiment, the first end portion covering portion 60 has the side plate portions 64 that stand upright from both sides of the heat dissipation plate portion 63 and are arranged between the side surfaces of the middle core portion 41 and the coil 30, but there is no limitation to this. For example, it is also possible to use a configuration in which the side plate portions 64 are not included.

In the above-described embodiment, the side plate portions 64 have the inclined portions 64a whose height from the heat dissipation plate portion 63 decreases toward the leading end in the direction of insertion into the coil 30, but there is no limitation to this. It is also possible to use a configuration in which the inclined portions 64a are not included.

In the above-described embodiment, the first end portion covering portion 60 has the heat dissipation plate portion 63 and the two arm portions 62, but there is no limitation to this. For example, the first end portion covering portion 60 may have the heat dissipation plate portion 63, and the second end portion covering portion 70 may have the two arm portions 62.

In the above-described embodiment, the heat dissipation plate portion 63 was provided at the first end portion covering portion 60, but there is no limitation to this. The heat dissipation plate portion 63 may also be provided at both the first end portion covering portion 60 and the second end portion covering portion 70.

In the above-described embodiment, the insulating resin portion 50 has the first end portion covering portion 60 and the second end portion covering portion 70 as primary molded portions and the molded resin portion 80 serving as a secondary molded portion that covers at least part of the coil 30 and the core 40, but there is no limitation to this. For example, the insulating resin portion 50 need not have the molded resin portion 80, and may have an insulating resin portion other than the molded resin portion 80.

The method for manufacturing the reactor 20 of the above-described embodiment may be changed as long as a similar reactor 20 can be manufactured.

In the above-described embodiment, the coil 30 is formed by performing edgewise winding of a coated rectangular wire and is formed into a rectangular tube shape, but it may be changed to another shape or configuration as long as it has a similar function.

The embodiments disclosed herein are exemplary in all respects, and the present disclosure is not limited to these examples. That is, the scope of the present disclosure is defined by the claims, and all modifications that are within the meaning and scope equivalent to the claims are intended to be encompassed therein.

What is claimed is:

1. A reactor to be disposed on a heat dissipation member, comprising:
a coil;
a core having a middle core portion disposed so as to penetrate through the inside of the coil, two side core portions that extend parallel to the middle core portion outside of the coil and are arranged side by side on sides of the middle core portion, and two end core portions arranged so as to connect an end portion of the middle core portion to end portions of the two side core portions; and
an insulating resin portion covering at least part of the coil and the core,
wherein the insulating resin portion has two end portion covering portions that can be arranged to cover both ends of the coil when the core is not attached and are arranged between the coil and the end core portion when the coil and the core are attached, and
at least one of the two end portion covering portions has a heat dissipation plate portion disposed between a lower surface of the middle core portion and the coil.

2. The reactor according to claim 1, wherein the end portion covering portions have side plate portions that stand upright from both sides of the heat dissipation plate portion and are arranged between side surfaces of the middle core portion and the coil.

3. The reactor according to claim 2, wherein the side plate portions have inclined portions whose height from the heat dissipation plate portion decreases toward a leading end in a direction of insertion into the coil.

4. The reactor according to claim 1, wherein the two end portion covering portions are constituted by a first end portion covering portion and a second end portion covering portion, and
the first end portion covering portion has the heat dissipation plate portion and two arm portions that extend to be connected to the second end portion covering portion and are capable of supporting the coil from below.

5. The reactor according to claim 1, wherein the insulating resin portion has the two end portion covering portions as primary molded portions, and a molded resin portion serving as a secondary molded portion that covers at least part of the coil and the core.

6. A method for manufacturing a reactor to be disposed on a heat dissipation member, the reactor including:
a coil;
a core having a middle core portion disposed so as to penetrate through the inside of the coil, two side core portions that extend parallel to the middle core portion outside of the coil and are arranged side by side on sides of the middle core portion, and two end core portions arranged so as to connect an end portion of the middle core portion to end portions of the two side core portions; and
an insulating resin portion covering at least part of the coil and the core,
the method comprising:
a primary molding step of molding two end portion covering portions that constitute at least part of the insulating resin portion, can be arranged to cover both ends of the coil when the core is not attached, and are arranged between the coil and the end core portion when the coil and the core are attached,
wherein in the primary molding step, a heat dissipation plate portion disposed between a lower surface of the middle core portion and the coil is molded in at least one of the two end portion covering portions.
